(19) United States
(12) Patent Application Publication
(10) Pub. No.: US 2011/0056747 A1
(43) Pub. Date: Mar. 10, 2011

(54) TERMINAL STRUCTURE FOR PLATE-SHAPED MEMBER HAVING CONDUCTING FUNCTION, AND PLATE-SHAPED MEMBER HAVING CONDUCTING FUNCTION

(76) Inventors: Yoshimitsu Matsushita, Tokyo (JP); Seiji Katakura, Tokyo (JP); Masami Sueda, Tokyo (JP)

(21) Appl. No.: 12/733,468

(22) PCT Filed: Sep. 2, 2008
(86) PCT No.: PCT/JP2008/065720

§ 371 Date: Mar. 15, 2010

(30) Foreign Application Priority Data
Sep. 4, 2007 (JP) 2007-228968

(51) Int. Cl. H02G 3/06

(52) U.S. Cl. 174/84 R

(57) ABSTRACT

Disclosed is a terminal structure, which suppresses the increase in the thickness size of a plate-shaped member disposed movably in the direction of main surfaces (14 and 15) so that it can be easily positioned and connected, and which is used in an automotive window glass pane (11) having a predetermined strength, an acid resistance and a weather resistance. The terminal structure (10) comprises a joint unit (5) and a terminal unit (3). The joint unit (5) includes an abutting portion (1) for abutting against the side faces of the end portion of the window glass pane, and protruding portions (2a and 2b) extending from the abutting portion (1) along the main surfaces (14 and 15) of the window glass pane. The terminal unit is disposed to lie within a width (W) of the joint unit in the thickness direction of the window glass pane, and at least a portion of the joint unit is jointed to a conductive film (12) so that the conductive film and the terminal unit are electrically connected.

### TECHNICAL FIELD

The present invention relates generally to a terminal structure for a conducting-function-imparted plate-shaped member as well as to the conductive plate-shaped member. More particularly, it relates to a terminal structure for a conductive-film-equipped automotive window glass pane that is moved by a window regulator in a direction of a main surface of the glass pane and to the window glass pane equipped with the terminal structure.

### BACKGROUND ART

Already known are automotive window panes having formed thereon, for example, an conductive film for generating heat in order to melt frost, snow, ice, or a similar material attached to a surface of a glass panel; an conductive film having an antenna function; an conductive film as a sensor for detecting cracks in a glass panel to prevent crime; or the like. Conductive films of such description are primarily formed on a windshield (front window pane) or rear glass (rear window pane), but in recent years are occasionally applied to side glass (side window pane) or a door window pane. There exist window panes that are disposed so as to be capable of opening and closing, such as a door window pane, on which an electrical conductor is formed in order to detect a finger or another object causing an obstruction.

FIG. 11 is a cross-sectional view showing a main section of a conventional window pane break detector according to Patent Document 1. In FIG. 11, the window pane break detector comprises a tape-shaped electrical conductor 102 for detecting breakage, formed on a main surface of reinforced door glass 101. The tape-shaped electrical conductor 102 is accommodated between door panels 103, 104 so as to be indiscernible from the outside when, for example, the reinforced door glass 101 is in a completely closed state. A power supply terminal 105 is joined to an end part of the tape-shaped electrical conductor 102 by, e.g., solder. In the window pane break detector described above, the tape-shaped electrical conductor 102 is located at a lower rim section of the reinforced door glass 101, making it possible to prevent breakages or connection faults resulting from contact with or abrasion against another member.

Patent Documents 2 and 3 are examples of publicly known documents that disclose conventional techniques relating to a power supply point or power supply terminal for supplying power to an conductive film formed on a main surface of the window pane.

FIG. 12 is a cross-sectional view showing a conventional metal terminal for supplying power to a conductive film formed on a surface of a glass panel according to Patent Document 2. FIG. 12 shows an conductive film 113 formed on a surface of a window pane 112, and a terminal structure 111 having a metal terminal 115 joined to the conductive film 113 using, e.g., a lead-free solder alloy 114. The terminal structure 111 is configured so as to be capable of supplying power from a power source (not shown) to the conductive film 113 through the metal terminal 115.

Patent Document 3 relates to a metal terminal for supplying power to an electrical circuit (i.e., electrical conductor layer) formed on a main surface of a glazing (i.e., glass panel) for a windscreen (i.e., front window) or a rear window of a vehicle. The metal terminal has a flat T-shape in plane view, and part of the longitudinal bar and the transverse bar that form the T-shape are fixed to the electrical conductor layer of the glass panel using solder and an adhesive. The distal portion of the longitudinal bar that forms the T-shape protrudes outside of the glass panel, and an electrical lead (i.e., an conductive wire) is connected to this portion.

An electrode lead-out device (see FIG. 3 of Patent Document 4) for supplying power to an electrode formed on an upper end part of a window pane is disclosed in Patent Document 4. The electrode lead-out device primarily comprises an conductive terminal having a U-shape in cross section so that the cross section of an end part follows an end part of the window pane that has been polished in a substantially semicircular shape, and further comprises a conductive wire connected to one end of the terminal.

However, in the conventional technique described in Patent Document 1 or 2, no consideration is given to minimizing the thickness of the glass panel that includes the electrode terminal and the conductive film formed on the main surface, and problems are presented when the glass panel provided with the terminal structure is used, for example, as an automotive window pane. In other words, for example, the power supply terminal 105 in Patent Document 1 shown in FIG. 11 and the metal terminal 115 in Patent Document 2 shown in FIG. 12 have a three-dimensional structure that protrudes in the thickness direction of the reinforced glass 101 for the door or the glass pane 112. This structure presents a problem in that when it is applied to an automotive window pane, the thickness increases considerably in comparison with the thickness of the glass panel, complicating the assembly process and compromising the reliability and safety of connection.

An automotive window pane is normally installed on a vehicle body following mounting of a power-supplying connection terminal provided to an conductive film formed on a glass panel in order to make the installation process more efficient. Accordingly, the width of protrusion (i.e., thickness) from the surface of the glass panel rarely presents a problem in the case of a fixed window panel, but when the glass panel is to be used as a door window pane that is moved up or down (i.e., is opened or closed) by, e.g., a window regulator, the glass panel must be inserted through an entrance into a space, called a door pocket, between two metal panels (in the vehicle body) that form the door. A problem is presented in that the glass panel cannot be inserted through the entrance when there is a protrusion that extends in the thickness direction of the glass panel. Another problem is that even when the glass panel can be inserted through the entrance, careful operations are required to prevent the glass panel from colliding with the periphery of the entrance, reducing the operating efficiency or changing the joining state by the collision and compromising the safety of the connection. Examples of a window provided with an openable and closable window pane include side and rear door windows and skylight (roof window).

Also, an automotive window pane slides along a frame. Therefore, rainwater can penetrate though a gap between the resin plate and the glass panel at the entrance when an conductive film has been formed on a surface of the glass panel facing the interior of the vehicle, and measures must be taken to prevent the ingress of rainwater.

The conventional technique disclosed in Patent Document 3 can minimize the increase in the thickness dimension of the glass panel, but the terminal structure is still difficult to position in relation to the glass panel, and the technique is not necessarily satisfactory in practical terms.

Also, the electrode lead-out device disclosed in FIG. 3 of Patent Document 3 has a shape in which the thickness dimension of the glass panel is kept to a minimum in comparison with the terminal in FIG. 11 or 12. However, Patent Document 4 merely conceptually describes a connection between the conductive terminal and the conductive wire as a connection at one end of the conductive terminal in the vicinity of a glass panel, and no specific connection structure is shown. Mere soldering or mere formation of a compression-bondable terminal structure is necessary, for example, in order to connect a conductive wire to an end portion of the conductive terminal. However, the thickness dimension of the glass panel increases in such a case, and caution must be exercised when the door is provided with a window pane in which the electrode lead-out device is mounted on the glass panel. In view of this, there has been a demand for developing a terminal structure which has minimal dimensions in the thickness direction of the glass panel and which can be appropriately used when the door is provided with a window pane in which the terminal structure is mounted on the glass panel.
Patent Document 1: Japanese Utility Model Post-Exam Publication No. 05-46532
Patent Document 2: International Publication WO 2003/076239
Patent Document 3: Japanese Patent Application Laid-Open Publication No. 2003-521093
Patent Document 4: Japanese Patent Application Laid-Open Publication No. 2007-137091

### DISCLOSURE OF THE INVENTION

An object of the present invention is to provide a terminal structure for a conducting-function-imparted plate-shaped member in which an increase in the thickness dimension of a plate-shaped member provided so as to be moveable in the plane direction of a main surface, such as an automotive window pane, is kept to a minimum, which can be positioned with ease, which has a predetermined level of strength, and which has high connection safety; and to provide a conductive-function-imparted plate-shaped member that is equipped with the terminal structure.

Another object of the present invention is to provide a terminal structure for a conducting-function-imparted plate-shaped member, and to provide a conducting-function-imparted plate-shaped member for which acid resistance and weather resistance can be achieved.

According to an aspect of the present invention, there is provided a terminal structure adapted to be connected to a conductive film provided on a surface of a plate-shaped member for imparting a conducting function to the plate-shaped member, the terminal structure comprising: a joint unit having an abutting portion for abutting against an end face of the conducting-function-imparted plate-shaped member and a protruding portion continuing from the abutting portion and extending along a main surface of the conducting-function-imparted plate-shaped member; and a terminal unit continuing from the abutting portion of the joint unit, wherein the terminal unit is disposed to lie within a width of the joint unit in a direction of thickness of the plate-shaped member, and the joint unit is at least partially joined to the conductive film to electrically connect the conductive film and the terminal unit.

With this arrangement, it becomes possible to reduce an increase in the thickness dimension of the conducting-function-imparted plate-shaped member to the necessary minimum and to reliably connect a control circuit and the conductive film formed on a surface of the plate-shaped member.

Preferably, the terminal structure is made of one of copper and a copper alloy, and the abutting portion and the protruding portion have respective thicknesses ranging from 0.8 mm to 1.0 mm. Thus, it is possible to ensure strength sufficient for a terminal structure.

Desirably, the abutting portion and the protruding portion jointly form the joint unit into an L-shape in cross section. Therefore, the joint unit can be used for a variety of plate-shaped members, from a thick conducting-function-imparted plate-shaped member to a thin conducting-function-imparted plate-shaped member, and can be positioned with ease.

In a preferred form, the protruding portion is provided in a pair, and the protruding portions and the abutting portion jointly form the joint unit into a U-shape in cross section. Thus, the joint unit can be easily positioned at an end part of the conducting-function-imparted plate-shaped member.

In a desired form, a space between the two protruding portions is equal to or greater than the thickness of the conducting-function-imparted plate-shaped member, and the two protruding portions are attached in such a manner as to sandwich an end part of the conducting-function-imparted plate-shaped member. Therefore, the two protruding portions can be attached so as to sandwich the end part of the conducting-function-imparted plate-shaped member.

According to another aspect of the present invention, there is provided a conducting-function-imparted plate-shaped member having a plate-shaped member movable in a surface direction thereof, a conductive film provided on a main surface of the plate-shaped member, and a terminal structure connected to the conductive film, the terminal structure comprising: a joint unit having an abutting portion for abutting against an end face of the plate-shaped member and a protruding portion continuing from the abutting portion and extending along the main surface of the plate-shaped member; and a terminal unit continuing from the abutting portion of the joint unit, wherein the terminal unit is disposed to lie within a width of the joint unit in a direction of thickness of the plate-shaped member, and the joint unit is at least partially joined to the conductive film to electrically connect the conductive film and the terminal unit.

With this arrangement, it is possible to provide a conducting-function-imparted plate-shaped member in which a control circuit and the conductive film formed on the surface of the plate-shaped member can be reliably connected by a terminal structure whose increase in dimension in the thickness direction can be kept to the necessary minimum.

Preferably, at least the joint unit of the terminal structure and the surface of the plate-shaped member in a vicinity of the joint unit are covered with an insulating resin. Insulation can thus be ensured and joint stability, acid resistance, and weather resistance can be enhanced.

Desirably, the insulating resin is an acrylic resin and/or a urethane resin. As a result, acid resistance, weather resistance, and the like are improved while economic efficiency is maintained.

In a preferred form, the insulating resin comprises an acrylic resin forming a cover member, and a urethane resin for filling in the gap between the cover member and the joint unit. Operating efficiency during formation of the insulating resin coating can therefore be improved.

It is desirable that the conducting-function-imparted plate-shaped member be a window pane to be openably/closably installed in a motor vehicle. The terminal structure may be mounted on an end part of the window pane and accommodated within a vehicle body of the motor vehicle. The terminal structure is therefore hidden from view and does not detract from the aesthetic appearance.

Preferably, the conductive film comprises at least one of a heating element, a conductor of a crack detection sensor and a conductor of an obstruction detection sensor. Therefore, the heating element, the electrical conductor of the crack detection sensor, and/or the electrical conductor of the obstruction detection sensor formed on the window pane can be reliably connected with a control circuit thereof, making it possible for each function to operate in a satisfactory manner.

Desirably, the heating element and the crack detection sensor conductor are formed on the main surface of the window pane, and the obstruction detection sensor conductor is formed on an end face of the window pane. Therefore, the conductive film can be connected to the control circuits in a state in which each of the functions can operate in a satisfactory manner.

### BRIEF DESCRIPTION OF THE DRAWINGS

FIG. 1 is a perspective view showing a terminal structure for a conducting-function-imparted plate-shaped member according to an embodiment of the present invention;

FIG. 2 is a front elevational view of the terminal structure of FIG. 1;

FIG. 3 is a left side elevational view showing the terminal structure of FIG. 1 as applied to an end part of a window pane;

FIG. 4 is a perspective view showing a first modification of the embodiment according to the present embodiment;

FIG. 5 is a view showing a second modification of the embodiment according to the present embodiment;

FIG. 6 is a view illustrating the terminal structure of the conducting-function-imparted plate-shaped member as applied to an automotive window pane;

FIG. 7 is an enlarged perspective view showing the vicinity of the terminal structure of FIG. 6;

FIG. 8 is a view illustrating a second embodiment;

FIG. 9 is a view illustrating a third embodiment;

FIG. 10 is a view illustrating a fourth embodiment;

FIG. 11 is a cross-sectional view showing a main section of a conventional window pane break detector disclosed in Patent Document 1; and

FIG. 12 is a cross-sectional view showing a conventional metal terminal for supplying power to an conductive film formed on a surface of a glass panel described in Patent Document 2.

### KEYS

1 abutting portion

2 protruding portion

2a protruding portion

2b protruding portion

3 terminal unit

5 joint unit

6 conductive wire

7 linking part

10 terminal structure

11 window pane

12 conductive film

13 end face

14 main surface

15 main surface

16 solder film

20 terminal structure

30 terminal structure

### BEST MODE FOR CARRYING OUT THE INVENTION

Preferred embodiments of the present invention will be described in detail below with reference to the accompanying drawings.

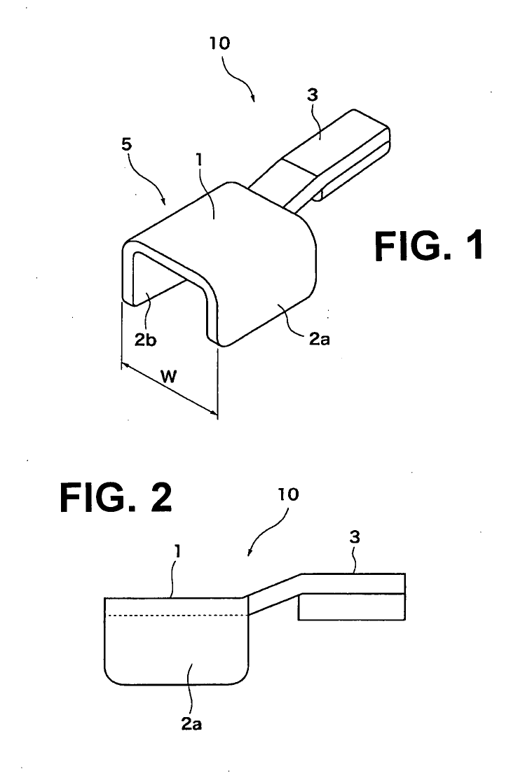

In FIGS. 1 through 3, the terminal structure for a conducting-function-imparted plate-shaped member is a terminal structure provided to, e.g., an automotive window pane, the structure comprising a joint unit 5 having an abutting portion 1 for abutting against an end face 13 of a window pane 11, and two protruding portions 2a, 2b connected so as to continue from the abutting portion 1 and extended along the main surfaces 14, 15 of the window pane 11; and a terminal unit 3 connected so as to continue from the abutting portion 1. The terminal unit 3 is disposed to be within the width W of the joint unit 5.

The term “main surface of the window pane 11” refers to the front or reverse surface of a plate-shaped window pane 11, and is a concept used to distinguish from an end surface (hereafter referred to as a “end face”) that defines the thickness of the glass panel.

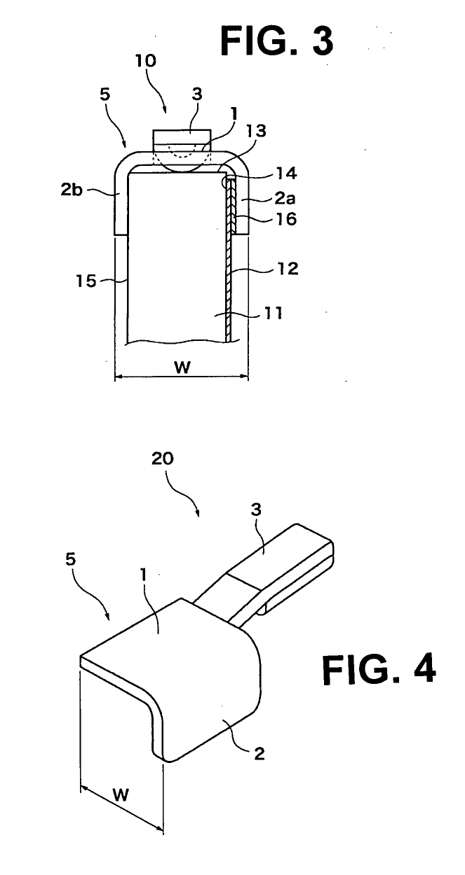

FIG. 3 shows a state in which a terminal structure 10 is attached to an end part of the window pane 11. In this state, the terminal unit 3 is provided so as to lie within the width W of the joint unit 5, desirably within the width of the window pane 11. Namely, it does not protrude beyond the width W of the joint unit 5. Thus, the terminal unit 3 is preferably provided so as to not protrude beyond the width W of the joint unit 5. An increase in the thickness dimension during attachment of the terminal structure 10 to the window pane 11 can thereby be kept to a minimum. The thickness dimension of the window pane 11 refers to the total thickness dimension of the window pane, including the thickness of the protruding portion of the terminal structure 10 used on the window pane 11, which in the present embodiment is the total thickness of the protruding portions 2a and 2b.

The space between the inner surface of each of the protruding portion 2a and the protruding portion 2b is equal to, or slightly larger than, the thickness of, e.g., the window pane 11. The end part of the window pane 11 thereby fits between the protruding portion 2a and the protruding portion 2b, and the protruding portion 2a and the protruding portion 2b are attached so as to sandwich the end part of the window pane 11. The joint unit 5 having a U-shape in cross section makes it possible to position the terminal structure relative to the window pane 11 with ease.

At least a part of the joint unit 5, i.e., some or all of an inner surface of at least one of the two protruding portions 2a, 2b and the abutting portion 1, is a joint portion joined with an conductive film 12 formed on the window pane 11, for example by soldering. A protrusion (not shown) for maintaining a constant solder film thickness may be provided to the soldered part.

The conductive film 12 is at least one of, e.g., a heating element, an electrical conductor of a crack detection sensor, and an obstruction detection sensor. An conductive film that functions as the heating element for melting frost, snow, ice, or a similar material attached to the window pane, or as an electrical conductor of a crack detection sensor for crime prevention is formed, e.g., on the main surface 14 or 15 of the window pane. On the other hand, an conductive film that functions as the electrical conductor of an obstruction detection sensor is formed, e.g., on the end face 13, or on the main surface 14 or 15 in the vicinity of the end face 13 of the window pane 11 (refer to FIG. 8, which is described further below). Portions other than those in which the conductive film is joined to the terminal structure (i.e., the power feed point) are preferably covered by an insulator. It is thereby possible, particularly when a plurality of conductive films is formed, to prevent the conductive films from short-circuiting as a result of, e.g., the presence of rainwater.

In a case in which the terminal structure is used on a window pane 11 on which the conductive film 12 is formed on the main surface 14, some or all of the protruding portion 2a facing the conductive film 12 is a soldered part, for example. In an application involving a window pane on which the conductive film is formed on both the front and reverse main surfaces 14 and 15, some or all of each of the two protruding portions 2a and 2b is a soldered part, for example.

In an application involving a window pane on which the conductive film 12 is formed on the end face 13, some or all of the abutting portion 1 is a soldered part, for example. In an application involving a window pane on which the conductive film 12 is formed on each of the end face 13 and one of the main surfaces 14 or 15, some or all of each of the abutting portion 1 and one of the protruding portions 2a or 2b is a soldered part, for example. In an application involving a window pane on which the conductive film 12 is formed on each of the end face 13 and the main surfaces 14 or 15, some or all of each of the abutting portion 1 and the protruding portions 2a and 2b is a soldered part, for example. In FIG. 3, the conductive film 12 is formed on the main surface 14 of the window pane 11, the inner surface of the protruding portion 2a is a soldered part, and a solder film 16 is formed between the protruding portion 2a and the conductive film 12.

Soldering is performed by, for example, applying solder in advance on a surface of the terminal structure 10 that faces the conductive film, positioning the terminal structure 10 by having the terminal structure abut or fit to a predetermined position on an end part of the window pane 11, and heating the structure to a predetermined temperature. The joining operation may be carried out using an conductive adhesive, such as a mixture of a resin and a metallic filler, instead of solder. An epoxy resin can be suitably used for the resin, and a silver filler can be suitably used for the metal filler.

The terminal structure 10 is made of, e.g., copper or a copper alloy, and the thickness of each of the abutting portion 1 and the protruding portions 2a, 2b is, e.g., from 0.8 mm to 1.0 mm. A thickness of from 0.8 mm to 1.0 mm makes it possible to obtain sufficient strength as a terminal structure. The copper is oxygen-free copper, and the copper alloy is, e.g., a copper alloy for terminals used in automotive vehicles (FAS-680; Furukawa Electric). The surface of the copper or the copper alloy is plated as required.

An end part of the terminal unit 3 has a cylindrical shape in order for, e.g., an conductive wire used for wiring to be attached by crimping. The conductive wire is connected to the end part of the terminal unit 3 by, e.g., inserting an end part of the conductive wire into the cylindrical portion and crimping the portion by using crimping equipment.

The method for connecting the end part of the terminal unit 3 to the conductive wire is not limited to crimping. Other possible methods include connection methods involving the use of a terminal covered by an insulating heat-shrunk tubing normally used in parts for connecting electrical wiring, or insertion-type connection methods involving the use of a concave terminal and a convex terminal covered by insulating tubing. In such a case, the maximum cross-sectional profile of the connecting part is preferably kept within the thickness dimension of the window pane.

In the present embodiment, the terminal structure 10 is provided to an automotive window pane 11 used as a conducting-function-imparted plate-shaped member. In FIG. 3, the terminal structure 10 is disposed at the predetermined position on the window pane 11, and a joint portion for joining the protruding portion 2a to the conductive film 12 is joined by a solder film 16. The joint portion for joining the protruding portion 2a to the conductive film 12 is preferably covered with a protective coating made of an insulating resin. More preferably, the entirety of the terminal structure 10, including the joint portion, is covered by the protective coating. In a case in which the terminal unit 3 is not covered by insulating tubing or a similar coating, the entirety of the terminal structure, including portions where an conductive wire is exposed, is more preferably covered by the protective coating after the terminal structure 10 has been connected to the conductive wire. It is thereby possible to provide insulation and prevent leak currents while also increasing the joint strength. It is also possible to ensure rainwater is prevented from entering, enhancing weather resistance and resistance against acid rain and the like. The insulating resin is preferably an acrylic resin and/or a urethane resin.

There are no particular limitations to the method for covering the terminal structure 10 with the insulating resin as a protective coating. For example, a paste made of the insulating resin is initially loaded into a cover member appropriately sized so as to be capable of covering the entirety of the terminal structure 10, and then the entire terminal structure 10 that has been joined to the conductive wire is covered with the cover member, whereby the terminal structure 10 may be covered with the insulating resin. The cover member is preferably one that is made of, e.g., an acrylic resin, and the resin paste used to fill the interior of the cover member is preferably a paste made of, e.g., a urethane resin. The cover member is preferably transparent to make it possible to determine the state in which the interior is filled with the resin.

Using the cover member and the resin paste that fills the interior of the cover member improves the workability of the coating process. An insulating film may be used instead of the cover member. When using a film member or a cover member that has been initially filled with the resin paste, the coating effect will be reduced if there is any location on the terminal structure 10 on which the resin paste has not been applied satisfactorily. Therefore, additional resin paste is preferably applied using a spatula or a similar tool. It is also possible to directly apply the resin paste to the terminal structure 10 using a spatula or a similar tool from the start and to form a protective coating, without using a cover member.

The terminal structure 10 is provided to the end part of the window pane 11 and is accommodated between two automotive door panels (i.e., within a vehicle body), for example. Therefore, attaching the terminal structure 10 in advance at the predetermined position on the window pane 11 increases the work efficiency when the window pane 11 is being installed. The conductive wire connected to the terminal unit 3 of the terminal structure 10 attached to the window pane 11 is preferably made to follow a side face of a lower end part of the window pane, and provisionally fastened, e.g., within a predetermined indentation, using an adhesive tape or the like. The window pane 11 can thereby be installed between the two door panels without any loss of workability arising from the terminal structure 10 having been attached in advance.

Also, the conductive wire connected to the terminal unit 3 and used for wiring can be provisionally fastened to an end part of the window pane 11 that corresponds to a point of connection with external wiring of a control circuit, the point of connection being between the two door panels or on the door panel facing the interior of the vehicle, thereby allowing the conductive wire to be readily connected to the external wiring and increasing the efficiency of the installation process.

Water-resistant means suitable for outdoor use is preferably used as a method for connecting the external wiring to the conductive wire connected to the terminal unit 3. Examples of connection methods of such description include a joining method involving the use of a solderless terminal coated with shrink tubing as described above, or an insertion-type joining method involving the use of a concave terminal and a convex terminal coated with insulating tubing. The insertion-type joining method is preferably used for reasons of workability.

In a case in which the connecting of the conductive wire to the terminal unit 3 on a window pane having a terminal structure 10 is performed as a post-process, the terminal unit 3 of the terminal structure 10 is preferably disposed at a position where the terminal unit 3 connected to the conductive film can be readily connected to the external wiring. Specifically, the terminal unit 3 of the terminal structure 10 is disposed in the vicinity of a linking part 7 (refer to FIG. 6) for linking the window pane to a window regulator, thereby allowing the external wiring to be readily connected to the terminal unit 3 of the terminal structure 10 via a through-hole used to aid the process of linking the window pane to the window regulator and formed on the door panel facing the interior of the vehicle.

According to the present embodiment, the window pane 11 used as a conducting-function-imparted plate-shaped member has a terminal structure 10, therefore making it possible to reliably connect the conductive film 12 to the external control circuit while minimizing any increase in the thickness dimension of the window pane 11. Also, the terminal structure 10 has a joint unit 5 that is U-shaped in cross section, therefore facilitating each of the processes of positioning and joining the terminal structure 10 to the end part of the window pane 11.

According to the present embodiment, furthermore, the terminal structure 10 will not be an obstruction when the window pane 11, to which the terminal structure 10 has been attached in advance, is installed between the two door panels; therefore, any loss of workability is prevented. In addition, no constituent member has a portion that is folded back, therefore making it possible to obtain a predetermined level of strength.

According to the present embodiment, furthermore, connection stability increases; and acid resistance against acid rain, weather resistance, and similar properties can be obtained when the entirety of the terminal structure 10, including the joint unit soldered to the conductive film 12, is covered with an insulating resin.

In the present embodiment, the end part of the terminal unit 3 may be shaped so as to be convex, and the end part of the conductive wire for connecting to the terminal unit 3 may be connected to a concave member. A plug-in type connection is obtained using the convex and concave forms. The end part of the terminal unit 3 may be of a concave shape, and a convex member may be joined to the end part of the wiring.

In the present embodiment, the conducting-function-imparted plate-shaped member is not limited to an automotive window pane; it may be applied to an exposed plate-shaped member with no channel member in the surrounding area, such as a window pane provided on a ceiling of a residential building or on a train or a similar vehicle; or to another plate-shaped member that opens and closes or moves in a reciprocating manner along a frame. The plate-shaped member is not limited to a glass panel, and may be, e.g., a resin plate such as a polycarbonate plate.

In the present embodiment, the joint unit 5 of the terminal structure may also be L-shaped in cross section. FIG. 4 is a perspective view showing a first modification of the present embodiment.

A terminal structure 20 for a conducting-function-imparted plate-shaped member shown in FIG. 4 has a joint unit 5 that is L-shaped in cross section, the joint unit 5 comprising an abutting portion 1 and a single protruding portion 2. Configuring the joint unit 5 to have an L-shape in cross section eliminates the need to sandwich the glass panel using two protruding portions, thereby making it possible to use the terminal structure 20 on plate-shaped members having a wide range of thicknesses. The joint unit is as effectively positioned on the plate-shaped member when the cross section is L-shaped as when it is U-shaped.

In a terminal structure 20 having a joint unit 5 that is L-shaped in cross section, an insulating coating provided to impart insulation, weather resistance, or other properties may be L-shaped in cross section to match the shape of the joint unit 5; however, a U-shape in cross section extending over both front and reverse main surfaces of the plate-shaped member is preferable. Forming an insulation coating that is U-shaped in cross section makes it possible to sandwich an end part of, e.g., a window pane from both surfaces, thereby increasing the coating effect.

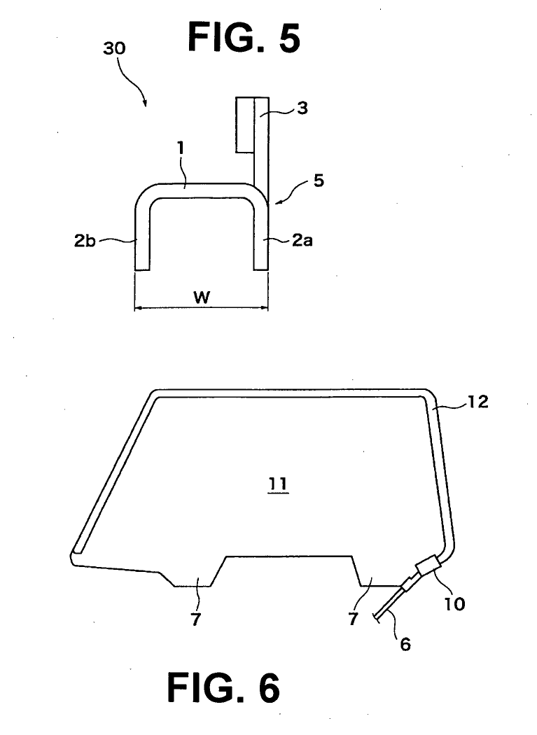

FIG. 5 is a side view showing a second modification of the present embodiment. A terminal structure 30 shown in FIG. 5 comprises an abutting portion 1 and protruding portions 2a and 2b connected so as to continue from the abutting portion 1, the abutting portion 1 and the protruding portions 2a and 2b forming a joint unit 5 that is U-shaped in cross section; and a terminal unit 3 formed so as to continue from the protruding portion 2a. The terminal unit 3 is provided so as to overlap with width W of the joint unit 5, and is further provided so as to not protrude beyond the width W of the joint unit 5. Specifically, the terminal unit 3 is provided so as to fit within the thickness dimension of the glass panel including the terminal structure.

Specific embodiments of the terminal structure for a conducting-function-imparted plate-shaped member according to the present invention will now be described.

### Embodiment 1

FIG. 6 is a diagram showing a state in which a terminal structure 10 for a conducting-function-imparted plate-shaped member is used on a window pane 11 for an automotive vehicle door. In FIG. 6, a conductive film 12 is formed on an end part and a main surface along a top edge and left and right edges of the window pane 11. The conductive film functions as, e.g., a conductor of an obstruction detection sensor. The conductive film 12 extends to a part of a lower edge of the window pane 11, and the terminal structure 10 is attached on a lower end of the window pane 11 to which the conductive film 12 is provided. The conductive film 12 may instead be provided on an end face, as shown in FIG. 8. A linking part 7 is a portion for linking the window pane to a window regulator.

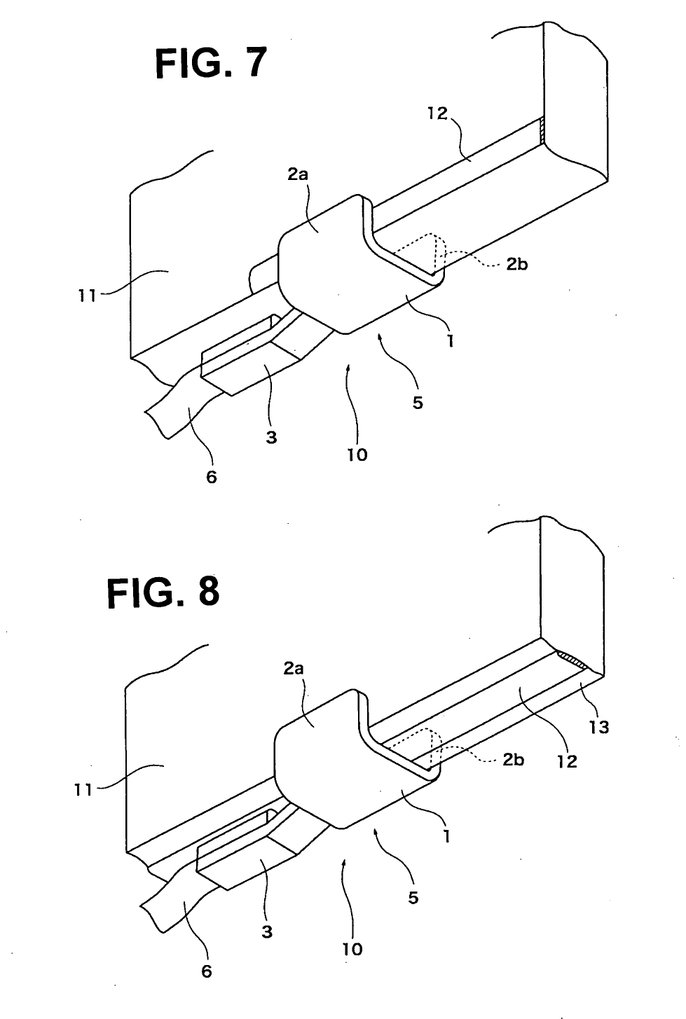

FIG. 7 is an expanded perspective view showing the vicinity of the terminal structure 10 shown in FIG. 6. The terminal structure 10 having a joint unit 5 that has a U-shape in cross section is used in the present embodiment shown in FIG. 7. The protruding portion 2a of the terminal structure 10 is made to abut against a part of the conductive film 12 extending to the lower end part of the window pane 11, and is joined to the part of the conductive film 12 by soldering (not shown). The conductive film 12 is connected to a control circuit of the obstruction detection sensor (not shown) via an conductive wire 6 and the protruding portion 2a, the abutting portion 1, and a terminal unit 3 of the terminal structure 10.

In such circumstances, when a hand, finger, or other object is trapped between a window frame (not shown) and the top-edge part of the window pane 11 constituting the conducting-function-imparted plate-shaped member shown in FIG. 6, a change occurs in the electrostatic capacity between, e.g., an electrode on the window-frame side and the terminal unit 3 joined to the conductive film 12. The control circuit senses the change in electrostatic capacity, whereby the presence of an obstruction is detected, and the window-pane raising operation (for closing the window) is stopped or another countermeasure is implemented.

According to the present embodiment, the following describes how to calculate the increase in the thickness dimension, and the total thickness, of the window pane 11 as a result of attaching the terminal structure.

The increase in thickness dimension is the sum of the thickness of each of two protruding portions 2a and 2b forming the joint unit 5 having a U-shape in cross section, the thickness of solder (not shown) formed on the surface of each of the protruding portions 2a and 2b, and the thickness of the protective coating (not shown) covering the entirety of the terminal structure 10.

A terminal structure having a protruding portion with a thickness of from 0.8 mm to 1.0 mm is normally used; therefore, assuming that the thickness of each of the protruding portions 2a and 2b is 0.8 mm, the increase in thickness corresponding to the protruding portions is 1.6 mm. Also, the thickness of the solder layer at the joint unit where the protruding portion 2a joins the conductive film 12 is normally limited to about 0.5 mm, and the increase in thickness corresponding to soldering is therefore assumed to be 0.5 mm.

The thickness of the insulating resin coating covering the entirety of the terminal structure 10 can normally be limited, in terms of the sum of thicknesses on front and reverse surfaces, to about 1.0 mm to 2.0 mm; therefore, the increase in thickness as a result of using the protective coating is assumed to be from 1.0 mm to 2.0 mm. Based on the assumptions described above, the total increase in the thickness dimension is as follows:

0.8×2+0.5+(1.0 to 2.0)→3.1 to 4.1 (mm)

A window pane 11 having a width of about 3 mm is normally used, and the width of the glass panel is therefore assumed to be 3.0 mm. Based on the assumptions described above, the total thickness dimension of the window pane 11 provided with the terminal structure 10 is as follows:

(3.1 to 4.1)+3.0→6.1 to 7.1 (mm)

(The tolerance for each of the thickness of the conductive film 12 and the thickness of the glass panel is ignored).

The maximum diameter of a connecting portion of the terminal unit 3 of the terminal structure 10 for connecting to the conductive wire 6 can be limited to about 5 mm, even when the insulating coating is taken into account. Therefore, the connecting portion for connecting to the conductive wire 6 is contained within the specification in the thickness direction of the glass panel.

### Embodiment 2

FIG. 8 is a diagram showing Embodiment 2. The embodiment shown in FIG. 8 differs from the first embodiment shown in FIG. 7 in that an conductive film 12 is provided to an end face 13 of the window pane 11. In FIG. 8, the terminal structure 10 abuts the end part of the window pane 11, and the abutting portion 1 and the conductive film 12 are joined by solder (not shown).

In the present embodiment, the increase in the thickness dimension of the window pane 11 as a result of the terminal structure 10 having been attached is equal to the increase in dimension in Embodiment 1 less the solder film thickness.

In other words, the increase in dimension is as follows:

(3.1 to 4.1)−0.5→2.6 to 3.6 (mm)

Also, the thickness dimension of the entirety of the window pane 11 provided with the terminal structure 10 is as follows:

(2.6 to 3.6)+3.0→5.6 to 6.6 (mm)

### Embodiment 3

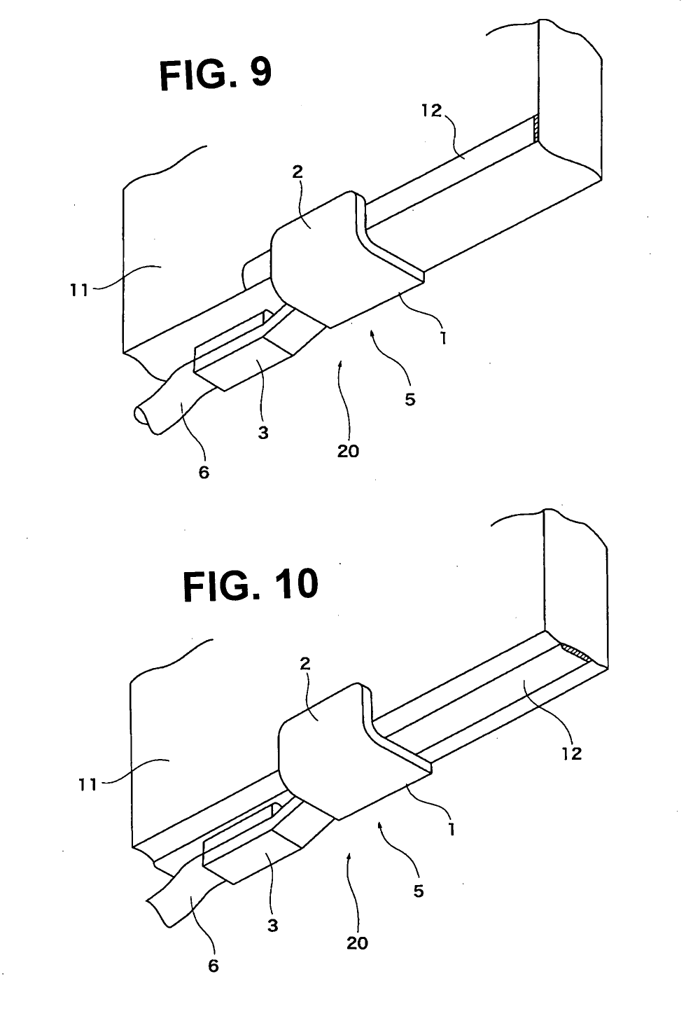

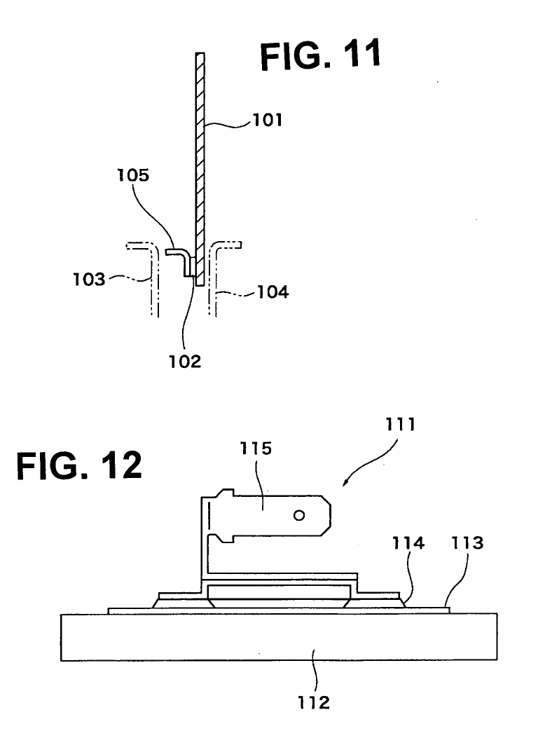

FIG. 9 is a diagram showing Embodiment 3. The embodiment shown in FIG. 9 differs from Embodiment 1 shown in FIG. 7 in that a terminal structure 20 having a joint unit that is L-shaped in cross section is provided as the terminal structure. In FIG. 9, the terminal structure 20 is positioned on the window pane 11 using a joint unit 5 of the terminal structure 20, the joint unit being L-shaped in cross section; and a protruding portion 2 and the conductive film 12 are joined by solder (not shown).

In the present embodiment, the increase in the thickness dimension of the window pane 11 as a result of the terminal structure 20 having been attached is the sum of the thickness of the protruding portion 2 forming the joint unit 5 having an L-shape in cross section, the thickness of a solder film (not shown) formed on a surface of the protruding portion 2, and the thickness of an insulating resin coating (not shown) covering the entirety of the terminal structure 20. Assuming that the thickness of the protruding portion 2 is 0.8 mm, the thickness of the solder film is 0.5 mm, and the sum of thicknesses of the insulating resin coating on front'and reverse surfaces is 1.0 mm to 2.0 mm, the total increase in thickness is as follows:

0.8+0.5+(1.0 to 2.0)→2.3 to 3.3 (mm)

Also, the thickness dimension including the thickness of the window pane 11 is as follows:

(2.3 to 3.3)+3.0→5.3 to 6.3 (mm)

### Embodiment 4

FIG. 10 is a diagram showing Embodiment 4. The embodiment shown in FIG. 10 differs from Embodiment 2 shown in FIG. 8 in that a terminal structure 20 having a joint unit that is L-shaped in cross section is provided as the terminal structure. In FIG. 10, the terminal structure 20 is positioned on the window pane 11 using a joint unit 5 of the terminal structure 20, the joint unit having an L-shape in cross section; and an abutting portion 1 and the conductive film 12 are joined by solder (not shown).

In the present embodiment, the increase in the thickness dimension of the window pane 11 as a result of the terminal structure 20 having been attached is equal to the increase in dimension in Embodiment 3 less the solder film thickness. Therefore, the total increase in thickness is as follows:

(2.3˜3.3)−0.5→1.8˜2.8 (mm)

The thickness dimension including the thickness of the window pane 11 is as follows:

(1.8˜0.8)+3.0→4.8˜5.8 (mm)

### Comparative Embodiment 1

A terminal structure having a height of from 8 to 15 mm is normally used for the terminal structure according to a conventional technique shown in FIG. 12. Assuming the thickness of the solder film to be 0.5 mm, the increase in the thickness dimension of the glass panel is, e.g., from 8.5 to 15.5 mm. Assuming the thickness of a glass panel 112 to be 3 mm, as with the above embodiments, then the total thickness, including the thickness of the glass panel, is as follows:

(8.5−15.5)+3.0→(11.5−18.5) (mm)

Results from each of Embodiments 1 to 4 and Comparative Embodiment 1 are summarized on Table 1.

TABLE 1

| | shape of | thicknesse of | increase in | |
|---|---|---|---|---|
| | joint | glass panel | thickness | total thickness |
| | unit | (mm) | (mm) | (mm) |
| Embodiment 1 | U-shaped in | 3 | 3.1-4.1 | 6.1-7.1 |
| | cross section | | | |
| Embodiment 2 | U-shaped in | 3 | 2.6-3.6 | 5.6-6.6 |
| | cross section | | | |
| Embodiment 3 | L-shaped in | 3 | 2.3-3.3 | 5.3-6.3 |
| | cross section | | | |
| Embodiment 4 | L-shaped in | 3 | 1.8-2.8 | 4.8-5.8 |
| | cross section | | | |
| Comparative | — | 3 | 8.5-15.5 | 11.5-18.5 |
| Embodiment 1 | | | | |

Table 1 shows that the increase in the thickness dimension of the glass panel due to the provision of the terminal structure according to each of Embodiments 1 to 4 is, in all cases, less than half that of Comparative Embodiment 1, showing that the increase in thickness can be dramatically reduced by applying the present invention.

It is evident that the increase in thickness according to each of Embodiments 1 to 4, in which a terminal structure having a joint unit with an L-shaped cross section is provided, is particularly small, being approximately one third or less that of Comparative Embodiment 1, in which a conventional technique is used.

### INDUSTRIAL APPLICABILITY

The conducting-function-imparted plate-shaped member according to the present invention is suitable for application on an automotive window pane that moves along front and reverse surfaces.

1. A terminal structure adapted to be connected to a conductive film provided on a surface of a plate-shaped member for imparting a conducting function to the plate-shaped member, the terminal structure comprising:
a joint unit having an abutting portion for abutting against an end face of the conducting-function-imparted plate-shaped member and a protruding portion continuing from the abutting portion and extending along a main surface of the conducting-function-imparted plate-shaped member; and
a terminal unit continuing from the abutting portion of the joint unit,
wherein the terminal unit is disposed to lie within a width of the joint unit in a direction of thickness of the plate-shaped member, and the joint unit is at least partially joined to the conductive film to electrically connect the conductive film and the terminal unit.

2. The terminal structure of claim 1, wherein the terminal structure is made of one of copper and a copper alloy, and the abutting portion and the protruding portion have respective thicknesses ranging from 0.8 mm to 1.0 mm.

3.-5. (canceled)

6. A conducting-function-imparted plate-shaped member having a plate-shaped member movable in a surface direction thereof, a conductive film provided on a main surface of the plate-shaped member, and a terminal structure connected to the conductive film, the terminal structure comprising:
a joint unit having an abutting portion for abutting against an end face of the plate-shaped member and a protruding portion continuing from the abutting portion and extending along the main surface of the plate-shaped member; and
a terminal unit continuing from the abutting portion of the joint unit,
wherein the terminal unit is disposed to lie within a width of the joint unit in a direction of thickness of the plate-shaped member, and the joint unit is at least partially joined to the conductive film to electrically connect the conductive film and the terminal unit.

7. The conducting-function-imparted plate-shaped member of claim 6, wherein at least the joint unit of the terminal structure and the surface of the plate-shaped member in a vicinity of the joint unit are covered with an insulating resin.

8. The conducting-function-imparted plate-shaped member of claim 7, wherein the insulating resin is an acrylic resin and/or a urethane resin.

9. The conducting-function-imparted plate-shaped member of claim 7, wherein the insulating resin comprises an acrylic resin forming a cover member, and a urethane resin for filling in a gap between the cover member and the joint unit.

10.-12. (canceled)
